(19) United States
(12) Patent Application Publication
(10) Pub. No.: US 2008/0285651 A1
(43) Pub. Date: Nov. 20, 2008

(54) SPATIO-TEMPORAL BOUNDARY MATCHING ALGORITHM FOR TEMPORAL ERROR CONCEALMENT

(75) Inventors: Oscar Chi Lim Au, Kowloon (HK); Yan Chen, Kowloon (HK)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE HONG KONG UNIVERSITY OF SCIENCE AND TECHNOLOGY, Kowloon (HK)

(21) Appl. No.: 11/750,144

(22) Filed: May 17, 2007

(51) Int. Cl. H04B 1/66

(52) U.S. Cl. 375/240.16; 375/E07.104

(57) ABSTRACT

A system and methodology for concealing an error in a video signal is provided. In accordance with one aspect of the present invention, the system and methodology employ a Spatio-Temporal Boundary Matching Algorithm, which utilizes a distortion function that takes into account both the spatial and temporal smoothness properties of a video sequence. Further, the methodology for concealing an error in a video signal comprises receiving a video signal having an erroneous frame, creating a candidate set of motion vectors, selecting a motion vector from the candidate set of motion vectors that best keeps temporal and spatial continuity through the erroneous frame, and reconstructing the erroneous frame using the selected motion vector.

### TECHNICAL FIELD

The subject invention relates generally to video signal communication, and more particularly to recovering lost motion vectors in a video signal.

### BACKGROUND OF THE INVENTION

The transmission of video signals on band-limited networks has recently increased in popularity due to the growth of the Internet and the success of wireless network technology. However, band-limited networks by their nature are often not reliable for video signal transmission. Specifically, transmission errors such as packet loss or bit corruption may occur during the transmission of a signal on a band-limited network, which can severely degrade the visual quality of a transmitted video sequence. Further, the effect of these errors can be increased due to the fact that a transmission error that corrupts a frame in a video signal may also propagate to succeeding frames due to predictive coding and variable length coding (VLC). Several error control technologies have traditionally been used in an attempt to mitigate the above effects of transmission errors on a video sequence. These traditional technologies include forward error correction (FEC), automatic retransmission request (ARQ), and error concealment (EC). Of these, error concealment has been the most widely used because it does not require extra bandwidth and may also avoid transmission delays.

Most conventional error concealment algorithms for video sequences make use of inherent spatial correlations (e.g., correlations between different areas of a given frame) and/or temporal correlations (e.g., correlations between different frames of a video sequence at a given space in the frames) among adjacent data in a video sequence. Conventional spatial approaches, such as maximally smooth recovery, utilize spatial correlations from a frame of a video sequence to recover lost or damaged data by utilizing the smoothness property of images. In contrast, conventional temporal approaches recover damaged data using temporal correlations between neighboring frames in a video sequence. Most conventional temporal approaches focus on the recovery of motion vectors. For example, some conventional temporal approaches attempt to recover a lost motion vector from a list of candidate motion vectors, which can include a zero motion vector, a collocated motion vector in a reference frame, and an average or median motion vector of spatially adjacent blocks in a video sequence.

Another conventional error concealment algorithm is the Boundary Matching Algorithm, which attempts to recover a motion vector from a set of candidate motion vectors by minimizing a distortion function between internal and external boundaries of a reconstructed block in a video sequence. This algorithm is adopted, for example, in the H.26L test model. Other conventional temporal approaches have been proposed that build upon the Boundary Matching Algorithm. One such approach attempts to recover a lost motion vector by using the Lagrange interpolation formula. Another such approach utilizes a Kalman-filtering technique to improve the accuracy of an obtained motion vector. Additionally, another conventional approach utilizes the Boundary Matching Algorithm as part of a spatial and temporal hybrid algorithm, wherein a lost block in a video sequence is first replaced using the Boundary Matching Algorithm and then a mesh-based warping procedure is applied in order to better match the content of the block with the correctly received surrounding areas.

Thus, many conventional temporal error concealment methods are based on the Boundary Matching Algorithm. However, the Boundary Matching Algorithm considers only spatial smoothness of a video sequence. For this reason, the Boundary Matching Algorithm and the conventional approaches that are based on said algorithm may not be able to select the best motion vector from the set of available candidates, resulting in a loss of accuracy.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides a system and methodology for improved error concealment for a transmitted video signal. In particular, the present invention employs a Spatio-Temporal Boundary Matching Algorithm, which utilizes a distortion function that takes into account both the spatial and temporal smoothness properties of a video sequence. In accordance with one aspect of the present invention, the distortion function includes a temporal distortion term and a spatial distortion term. The temporal distortion term can be defined as an average sum of absolute differences between data at the external boundary of a recovered block in a current frame and corresponding data at the external boundary of a block in a reference frame. Additionally, the spatial distortion term can be defined as an average sum of the absolute changes of a Laplacian estimator along the normal direction at the internal boundary of a recovered block. By utilizing a distortion function that takes into account both spatial distortion and temporal distortion, the present invention can provide greater accuracy than conventional error concealment approaches that employ the Boundary Matching Algorithm.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a system for communicating and processing a video signal in accordance with an aspect of the present invention.

FIG. 2 illustrates an example boundary matching relationship typically used in conventional error concealment approaches.

FIG. 3 is a block diagram of a system that facilitates error concealment for a video signal in accordance with an aspect of the present invention.

FIG. 4 illustrates image quality data for an exemplary error concealment system in accordance with an aspect of the present invention.

FIG. 5 illustrates image quality data for an exemplary error concealment system in accordance with an aspect of the present invention.

FIG. 6 is a flowchart of a method of processing a video signal in accordance with an aspect of the present invention.

FIG. 7 is a flowchart of a method of concealing an error in a video signal in accordance with an aspect of the present invention.

FIG. 8 is a flowchart of a method of concealing an error in a video signal in accordance with an aspect of the present invention.

FIG. 9 is a block diagram of an example operating environment in which the present invention may function.

FIG. 10 is a block diagram of an example networked computing environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The components may communicate via local and/or remote processes such as in accordance with a signal having one or more data packets (e.g., data from one component interacting with another component in a local system, distributed system, and/or across a network such as the Internet with other systems via the signal).

Additionally, while the present invention is generally described with respect to a Spatio-Temporal Boundary Matching Algorithm for error concealment in a transmitted video signal, those skilled in the art will recognize that the present invention can be used in connection with any error concealment algorithm that is based on the recovery of a lost or corrupted motion vector with little added complexity. Additionally, those skilled in the art will recognize that the present invention can also be applied to real-time applications. It is to be appreciated that the systems and/or methods of the present invention can be employed in connection with any suitable algorithm in any suitable application and all such algorithm(s) and application(s) are intended to fall within the scope of the hereto appended claims.

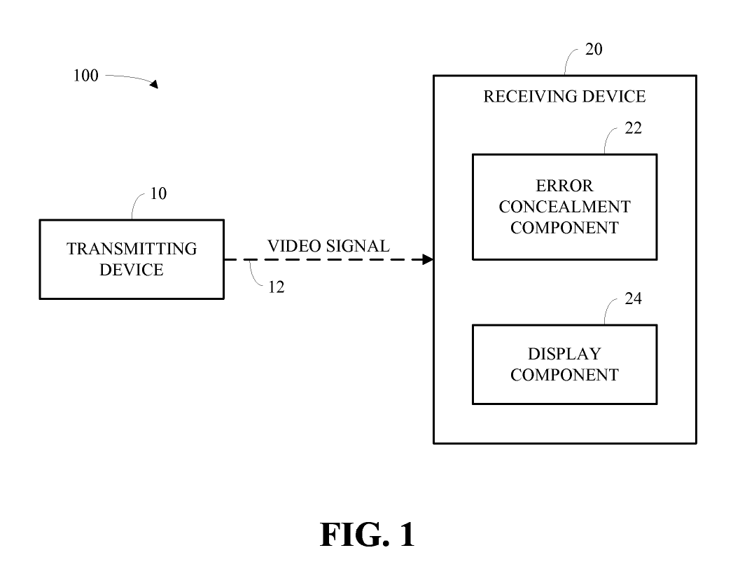

Referring to FIG. 1, a high-level block diagram of a system 100 for communicating and processing a video signal 12 in accordance with an aspect of the present invention is illustrated. In one example, system 100 includes a transmitting device 10 that sends one or more video signals 12 to a receiving device 20 that is communicatively connected to the transmitting device 10. By way of non-limiting example, transmitting device 10 and receiving device 20 can be communicatively connected via a wired (e.g., Ethernet, IEEE-802.3, etc.) or wireless (IEEE-802.11, Bluetooth™, etc.) networking technology. Additionally, transmitting device 10 and receiving device 20 can be directly connected to one another or indirectly connected through a third party device (not shown). For example, transmitting device 10 can be a web server and the receiving device 20 can be a client computer that accesses transmitting device 10 over the Internet via an Internet service provider (ISP). As another example, receiving device 20 can be a mobile terminal that accesses a video signal 12 from transmitting device 10 via a cellular communications network such as the Global System for Mobile Communications (GSM), a Code Division Multiple Access (CDMA) network, and/or another suitable cellular communications network. Additionally, receiving device 20 can include a display component 24 that displays a video signal 12 received from transmitting device 10. In one example, the display component 24 can also perform appropriate pre-processing operations on video signal 12 prior to display, such as rendering, buffering, and other suitable operations.

In accordance with one aspect, the connection between transmitting device 10 and receiving device 20 may be band-limited. Thus, as a result of the band-limited nature of the connection between transmitting device 10 and receiving device 20 and/or other appropriate factors, transmission errors may be present in video signal 12 when it reaches receiving device 20. These transmission errors can include, for example, packet loss and bit corruption. As a result of these transmission errors, data within video signal 12 can become lost or damaged, thereby causing one or more frames of video signal 12 or blocks of data within a frame of video signal 12 to display improperly or not display at all. This can create unsightly defects in video signal 12 as displayed by display component 24. Accordingly, to improve the appearance of a video signal 12 when an error is encountered, receiving device 20 can include an error concealment component 22. In one example, error concealment component 22 can conceal one or more transmission errors in a video signal 12 by interpolating missing or damaged data in the video signal 12. Error concealment component 22 can then provide its interpolation of the missing or damaged data to the display component 24 for display with correctly received portions of video signal 12, thereby reducing the appearance of defects in video signal 12 due to transmission errors. By doing so, error concealment component 22 can provide a generally more pleasant appearance for video signal 12.

In accordance with another aspect, error concealment component 22 can conceal transmission errors in video signal 12 at least in part by using a Spatio-Temporal Boundary Matching Algorithm (STBMA). By using a STBMA, error concealment component 22 can interpolate missing and/or damaged data in video signal 12 and use this interpolation to reconstruct frames containing the missing and/or damaged data. In one example, a STBMA used by error concealment component 22 involves finding corresponding data from a correctly received reference frame in video signal 12 that best minimizes temporal distortion (e.g., distortion between different frames of a video sequence at a given block location) and spatial distortion (e.g., distortion between neighboring blocks in a given frame) in the video sequence represented by video signal 12. Additionally, error concealment component 22 can perform one or more transformations on data retrieved from a reference frame to better minimize spatial distortion. In one example, transformations can be performed iteratively until a point of convergence is reached.

In a specific, non-limiting example, lost or corrupted data in video signal 12 can correspond to a lost or damaged macroblock in one or more frames of video signal 12. Error concealment component 22 can then use a STBMA to find data in video signal 12 that minimizes temporal distortion by finding a macroblock in a reference frame that minimizes the differences between pixels at the external boundary of the macroblock found in the reference frame and corresponding pixels in the external boundaries of macroblocks that border the lost or damaged macroblock. Concurrently and/or subsequently, the STBMA can be used to find data in the reference frame that minimizes spatial distortion at least in part by determining a transformation that minimizes the difference between a gradient across the internal boundary of the lost or damaged macroblock and a gradient across the internal boundary of a macroblock in the same location in one or more immediately preceding frames. Once error concealment component 22 has used the STBMA to find data that minimizes temporal and spatial distortion, that data can be used to reconstruct the lost or corrupted data in video signal 12. In an alternative non-limiting example, lost or corrupted data in video signal 12 can correspond to a missing motion vector. Error concealment component 22 can then utilize a STBMA to determine a motion vector that best minimizes temporal and spatial distortion in video signal 12 in a similar manner to the previous example. From this, error concealment component 22 can then reconstruct the lost or corrupted data in video signal 12 using the determined motion vector.

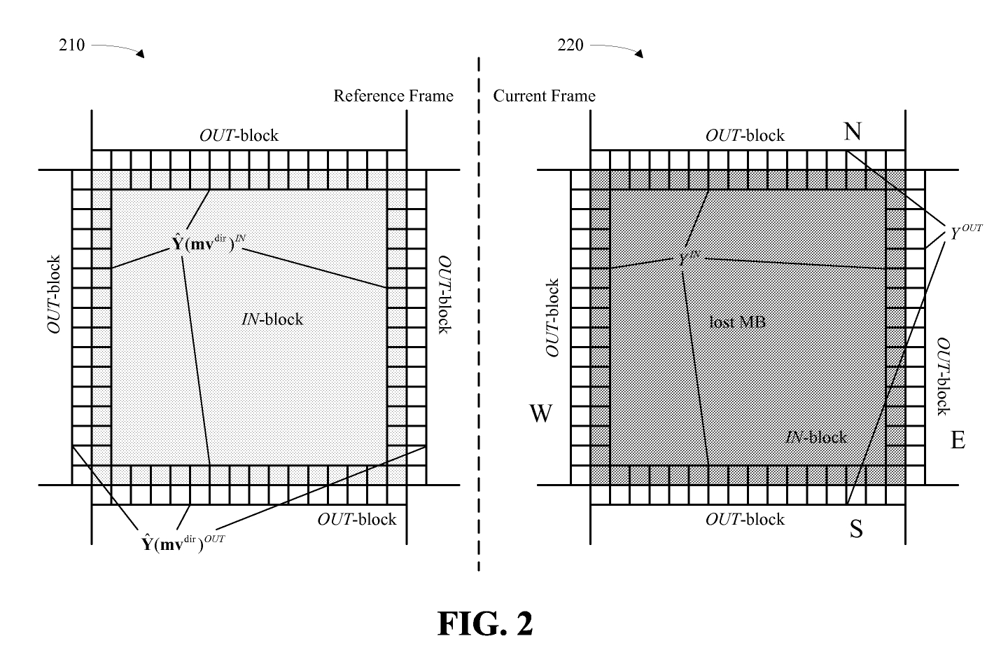

Referring now to FIG. 2, an example boundary matching relationship typically used in conventional error concealment approaches is illustrated. More particularly, FIG. 2 illustrates a boundary matching relationship between a current frame 220 and a reference frame 210 that is commonly used in the conventional Boundary Matching Algorithm (BMA). Traditionally, the BMA can recover a lost motion vector resulting from a lost or damaged macroblock in a video signal (e.g., video signal 12) from a set of candidate motion vectors by minimizing side match distortion between the internal and external boundary of a reconstruction of the lost or damaged macroblock. The distortion function can be determined by the sum of absolute differences between a predicted block and its neighboring blocks at the boundary of the current macroblock. This can be expressed as the following:

$${D}_{sm} = \frac{1}{M} {\sum }_{j = 1}^{M} \vert {\hat{Y} ( {mv}^{dir} )}_{j}^{IN} - {Y}_{j}^{OUT} \vert , \qquad ( 1 )$$

where Ŷ(mv^{dir})ⱼ^{IN} is the j-th Y value in the boundary of the predicted IN-block in reference frame 210, Yⱼ^{OUT} is the j-th Y value in the boundary of the OUT-blocks in current frame 220, and M is the total number of pixels in the boundaries to be calculated. In one example, the set of candidate motion vectors can include a zero motion vector (i.e., a motion vector representing no motion), a collocated motion vector in reference frame 210, and motion vectors corresponding to neighboring blocks. The BMA can then select a motion vector from the set of candidate motion vectors that minimizes the side distortion Dₛₘ. When more than one neighboring macroblock is correctly received, the above distortion function may be calculated only on the boundary of the correctly received neighboring macroblocks. Otherwise, concealed neighboring macroblocks may be used in the above calculation.

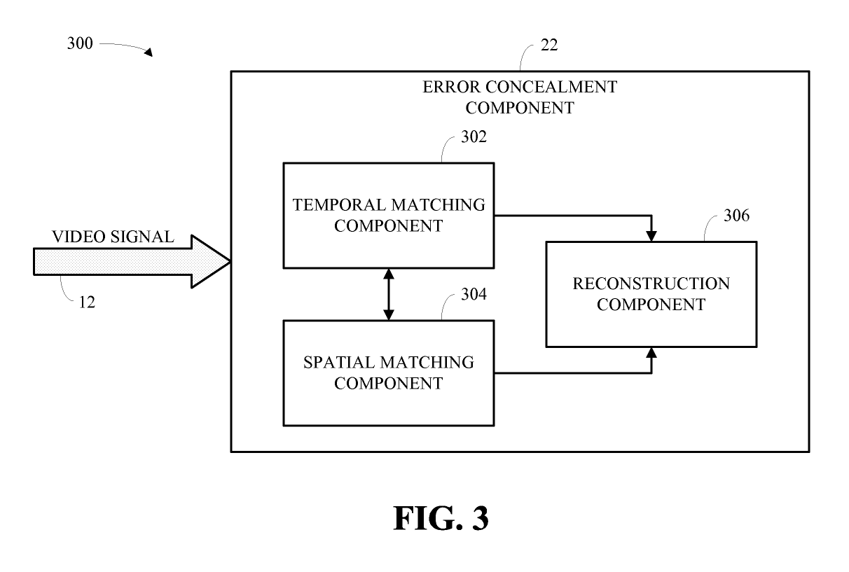

Turning to FIG. 3, a block diagram of a system 300 that facilitates error concealment for a video signal in accordance with an aspect of the present invention is illustrated. System 300 includes an error concealment component 22 that can conceal one or more transmission errors in a video signal 12. In one example, error concealment component 22 includes a temporal matching component 302 and a spatial matching component 304, which can operate individually or in tandem to perform a Spatio-Temporal Boundary Matching Algorithm (STBMA) that facilitates error concealment for video signal 12. Error concealment component 22 can further include a reconstruction component 306 that reconstructs one or more frames of a video signal 12 having transmission errors at least in part by utilizing the result of the STBMA employed by temporal matching component 302 and spatial matching component 304. Like the BMA illustrated in FIG. 2, one example STBMA employable by error concealment component 22 can utilize smoothness properties of a video signal 12 to recover a lost motion vector by selecting from a set of candidate motion vectors. However, because the traditional BMA only considers spatial smoothness of a video sequence, it may not always select the best motion vector from the candidate set of motion vectors. In contrast, the STBMA employed by error concealment component 22 can utilize a more accurate distortion function that considers both spatial and temporal smoothness of a video sequence. Thus, error concealment component 22 can reconstruct lost or damaged data in a video sequence 12 with greater accuracy than is possible under a conventional approach utilizing the traditional BMA.

In accordance with one aspect, the distortion function employed by error concealment component 22 in its STBMA is determined by a spatial distortion term Dₛₘ^{spatial} and a temporal distortion term Dₛₘ^{temporal}. Accordingly, the distortion function can be expressed as follows:

$${D}_{sm} = {\sum }_{i ∈ ( N , W , S , E )} α \times {D}_{sm}^{spatial} ( i ) + ( 1 - α ) \times {D}_{sm}^{temporal} ( i ) , \qquad ( 2 )$$

where N, W, S, and E respectively represent North, West, South, and East in a similar manner to the boundary matching relationship illustrated in FIG. 2 and α is a weighting factor that can be represented by a real number between 0 and 1.

In one example, the temporal distortion term Dₛₘ^{temporal} in Equation (2) is utilized to measure how well a candidate motion vector can keep temporal continuity. By way of a non-limiting example, the temporal distortion term Dₛₘ^{temporal} can be defined such that the smaller Dₛₘ^{temporal} is, the better a candidate motion vector can keep temporal continuity through an erroneous frame. As another specific, non-limiting example, Dₛₘ^{temporal} can be further defined as the average sum of absolute differences between a predicted OUT-block and the neighboring blocks at its external boundary, which can be expressed as follows:

$${D}_{sm}^{temporal} ( i ) = \frac{1}{M} {\sum }_{j = 1}^{M} \vert {\hat{Y} ( {mv}^{dir} )}_{j}^{OUT} ( i ) - {Y}_{j}^{OUT} ( i ) \vert , \qquad ( 3 )$$

where mv^{dir} is a currently considered candidate motion vector and M is the number of boundary pixels at each direction. Further, Ŷ(mv^{dir})ⱼ^{OUT} represents the j-th Y value in the boundary of the predicted OUT-blocks in a reference frame (e.g., reference frame 210) and Yⱼ^{OUT} represents the j-th Y value in the boundary of the OUT-blocks in the current frame (e.g., current frame 220). As a further non-limiting example, the lost or damaged data in video signal 12 can correspond to a missing or corrupted macroblock, and Dₛₘ^{temporal} can be determined at least in part by a temporal matching component 302 in error concealment component 22 that selects a macroblock from a frame in video signal 12 such that the selected macroblock minimizes the temporal distortion between the missing or corrupted macroblock and its neighboring macroblocks. A motion vector from the candidate set of motion vectors can then be selected that corresponds to the selected macroblock. The lost or damaged data in video signal 12 can then be reconstructed by reconstruction component 306 from the selected motion vector.

In another example, the spatial distortion term Dₛₘ^{spatial} in Equation (2) is used to measure how well a candidate motion vector can keep spatial continuity. By way of a non-limiting example, the spatial distortion term Dₛₘ^{spatial} can be defined such that the smaller Dₛₘ^{spatial} is, the better a candidate motion vector can keep spatial continuity through an erroneous frame. As another specific, non-limiting example, Dₛₘ^{spatial} can be defined as the average sum of absolute changes of a Laplacian estimator along the normal direction at an internal boundary of a recovered block, thereby allowing a determination of the extent to which one or more isophotes at the boundary are continuous. This can be expressed as follows:

$$\begin{matrix}{D}_{sm}^{spatial} ( i ) = \frac{1}{M} {\sum }_{j = 1}^{M} \vert ∇ ( Δ {Y}_{j}^{IN} ( i ) ) \cdot \vec{{n}_{j}} ( i ) \vert \times {k}_{j} ( i ) ; & ( 4 ) \\ \vec{{n}_{j}} ( i ) = \frac{{∇}^{⊥} {Y}_{j}^{IN} ( i )}{\vert {∇}^{⊥} {Y}_{j}^{IN} ( i ) \vert} ; {k}_{j} ( i ) = \frac{\vert ∇ {Y}_{j}^{IN} ( i ) \vert}{\vert ∇ ( Δ {Y}_{j}^{IN} ( i ) ) \vert} , & ( 5 )\end{matrix}$$

where M is the number of boundary pixels at each direction and Yⱼ^{IN} represents the j-th Y value in the boundary of the IN-blocks in the current frame (e.g., current frame 220). In addition, kⱼ(i) is a scaling factor and \vec{n}ⱼ represents the normal direction of the j-th boundary pixel of the IN-blocks. Further, as used in Equations (4) and (5),

$$∇ . = [ \frac{\partial .}{\partial x} , \frac{\partial .}{\partial y} ]$$

is the gradient operator,

$${∇}^{⊥} . = [ - \frac{\partial .}{\partial y} , \frac{\partial .}{\partial x} ]$$

is the normal operator whose direction is orthogonal to the gradient direction, and

$$Δ . = \frac{{\partial }^{2} .}{{\partial }^{2} x} + \frac{{\partial }^{2} .}{{\partial }^{2} y}$$

is the Laplacian operator. In one example, these operators can be calculated as follows:

$$\begin{matrix}\vert {∇}^{⊥} Y ( i , j ) \vert = \vert ∇ Y ( i , j ) \vert = \sqrt{{[ \frac{\partial Y ( i , j )}{\partial x} ]}^{2} + {[ \frac{\partial Y ( i , j )}{\partial y} ]}^{2}} ; & ( 6 ) \\ \frac{\partial Y ( i , j )}{\partial x} = \frac{Y ( i + 1 , j ) - Y ( i - 1 , j )}{2} \\ \frac{\partial Y ( i , j )}{\partial y} = \frac{Y ( i , j + 1 ) - Y ( i , j - 1 )}{2} ; & ( 7 ) \\ \frac{{\partial }^{2} Y ( i , j )}{{\partial }^{2} x} = Y ( i + 1 , j ) + Y ( i - 1 , j ) - 2 Y ( i , j ) . \\ \frac{{\partial }^{2} Y ( i , j )}{{\partial }^{2} y} = Y ( i , j + 1 ) + Y ( i , j - 1 ) - 2 Y ( i , j ) & ( 8 )\end{matrix}$$

As a further non-limiting example, the lost or damaged data in video signal 12 can correspond to a missing or corrupted macroblock, and Dₛₘ^{spatial} can be determined at least in part by a spatial matching component 304 in error concealment component 22 that determines a transformation on a given macroblock that best preserves a gradient across the boundary of the given macroblock through a frame containing the missing or corrupted macroblock and one or more immediately preceding frames. The transformation can involve, for example, adjusting the intensity of one or more pixels in the given macroblock to account for changes in the video signal 12 over time, such as changes in brightness, zoom, rotation, and/or other appropriate changes. In one example, the spatial matching component 304 can perform a transformation iteratively on a given macroblock until sufficient convergence is reached. In another example, spatial matching component 304 can work in conjunction with temporal matching component 302. As an example, the spatial matching component 304 can perform one or more transformations on a macroblock selected by temporal matching component 302. After spatial matching component 304 completes any appropriate transformations, a motion vector from the candidate set of motion vectors can then be selected that reflects the transformations performed by spatial matching component 304 and the lost of damaged data in video signal 12 can be reconstructed by reconstruction component 306 using the selected motion vector.

In accordance with one aspect, the STBMA employable by error concealment component 22 can operate similarly to the traditional BMA in that if more than one neighboring macroblock is correctly received, the distortion function can be calculated only on the boundary of those correctly received neighboring macroblocks. Otherwise, concealed neighboring macroblocks can also be used in the calculation. In one example, error concealment component 22 can employ a STBMA to select a motion vector from a candidate set that minimizes the overall side distortion Dₛₘ.

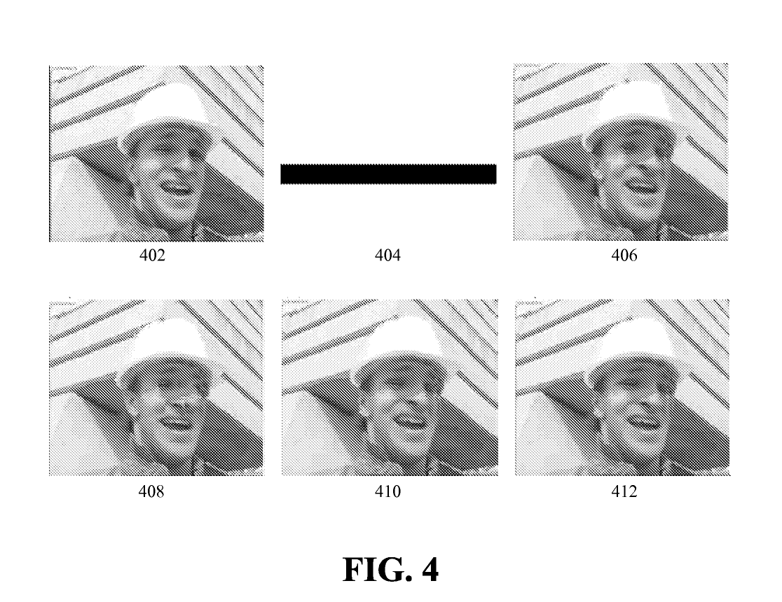

Referring now to FIG. 4, image quality data obtained from an evaluation of an example STBMA for error concealment that can be employed in accordance with an aspect of the present invention (e.g., by error concealment component 22) is illustrated. The evaluation is based on the H.264 codec and was performed using JM9.0 reference software. During the evaluation, the performance of the example STBMA was compared to the performance of an inter-frame concealment feature implemented in the reference software that is based on the traditional BMA. Each algorithm was evaluated using test sequences in Quarter Common Intermediate Format (QCIF) that were encoded at a 30 Hz frame rate. Additionally, an intraframe (“I-frame”) was encoded every ten frames in each test sequence and no bi-directional frames (“B-frames”) were used. Slice mode was enabled for each test sequence such that each slice contains a row of macroblocks. Further, no intra mode was used in predictive frames (“P-frames”), and the quantization parameter for each test sequence was set to be 28.

The reference software utilized in the evaluation conceals I-frames spatially using weighted pixel averaging. However, weighted pixel averaging for I-frames is inefficient and produces extremely blurred recovered macroblocks. In light of the fact that a transmission error that corrupts a given frame may also propagate to succeeding frames in a predictive coding scheme, badly concealed macroblocks in the I-frames could greatly degrade the quality of following P-frames. Thus, in order to better compare the example STBMA with the traditional BMA, both of which are primarily aimed at interframe concealment, transmission errors in the evaluation only occur in P-frames. Specifically, for each P-frame, a number of slices were randomly dropped to simulate transmission errors according to an error pattern. Packet loss rates of 1%, 2%, 10%, and 20% were tested in the evaluation.

Two test sequences, herein referred to as coastguard and foreman, were used in the evaluation. Each corrupted frame in the test sequences, which respectively serve as references for succeeding frames, were concealed by the traditional BMA and an example STBMA. In the evaluations, the weighting factor α for the STBMA as used in Equation (2) was tested at 0, 0.5 and 1. Thus, as can be appreciated from Equation (2), the tested values used for the weighting factor α have the effect of causing the STBMA to consider only the temporal smoothness property when α=0, only the spatial smoothness property when α=1, and both the spatial and temporal smoothness properties when α=0.5.

Based on the above evaluations, the average peak signal-to-noise ratio (PSNR) of the reconstructed frames in the coastguard and foreman test sequences using the traditional BMA and an example STBMA with weighting factors α of 0, 0.5, and 1 is shown below by Table 1:

TABLE 1
Average Luminance PSNR of all frames using BMA and STBMA.

Packet Loss Rate

| | 1% | 2% | 10% | 20% |
|---|---|---|---|---|
| Coastguard | | | | |
| H.264 (BMA) | 33.7223 | 33.164 | 32.2824 | 30.4508 |
| STBMA α = 1 | 33.8711 | 33.1566 | 32.1517 | 30.3713 |
| STBMA α = 0 | 33.8351 | 33.0775 | 32.2093 | 30.4245 |
| STBMA α = 0.5 | 34.0728 | 33.2646 | 32.4355 | 31.4467 |
| Foreman | | | | |
| H.264 (BMA) | 36.0188 | 35.591 | 32.4252 | 30.4511 |
| STBMA α = 1 | 35.8007 | 35.7282 | 32.651 | 30.3713 |
| STBMA α = 0 | 36.0223 | 35.8271 | 33.198 | 31.1868 |
| STBMA α = 0.5 | 36.0839 | 35.9493 | 33.473 | 31.3139 |

As illustrated by Table 1, the example STBMA can provide higher PSNR performance compared with conventional BMA when the weighting factor is set to be 0.5. Additionally, since Table 1 represents PSNR data for all frames in the coastguard and foreman test sequences including non-corrupted frames, the average PSNR of only the corrupted frames of each sequence at the same packet loss rates were also calculated in order to better compare the two algorithms as shown below in Table 2:

TABLE 2
Average Luminance PSNR of corrupted frames
using BMA and STBMA.

Packet Loss Rate

| | 1% | 2% | 10% | 20% |
|---|---|---|---|---|
| Coastguard | | | | |
| H.264 (BMA) | 32.3977 | 31.4643 | 31.7638 | 29.7985 |
| STBMA α = 1 | 32.8627 | 31.4468 | 31.6082 | 29.4665 |
| STBMA α = 0 | 32.7499 | 31.2585 | 31.6767 | 29.7685 |
| STBMA α = 0.5 | 33.493 | 31.704 | 31.9461 | 30.9301 |
| Foreman | | | | |
| H.264 (BMA) | 34.8484 | 34.1208 | 31.5713 | 29.5573 |
| STBMA α = 1 | 34.1665 | 34.4475 | 31.8402 | 29.4665 |
| STBMA α = 0 | 34.8591 | 34.6829 | 32.4914 | 30.3933 |
| STBMA α = 0.5 | 35.0515 | 34.9739 | 32.8187 | 30.5377 |

Thus, as illustrated in Table 2, a STBMA can obtain a gain of up to 1.24 dB gain when the STBMA is configured to consider both spatial and temporal smoothness by setting the weighting factor α to 0.5.

In accordance with these evaluations, FIG. 4 illustrates the visual qualities of the reconstructed frames in the foreman test sequence. Image 402 is an original video frame in the foreman test sequence, and image 404 is an error-mask frame that illustrates the slice that was removed from the corrupted frames in the test sequence. Based on the original frame 402 and error mask 404, image 406 shows s reconstruction of original frame 402 using the traditional BMA. In contrast, images 408, 410, and 412 show the results of error concealment by the example STBMA where the weighting factor α used by the STBMA is respectively set to be 1, 0, and 0.5. As illustrated by FIG. 4, image 412 corresponding to the concealed frame provided by the STBMA with weighting factor α=0.5 is smoother and has less artifacts compared to image 406 corresponding to the concealed frame provided by the traditional BMA.

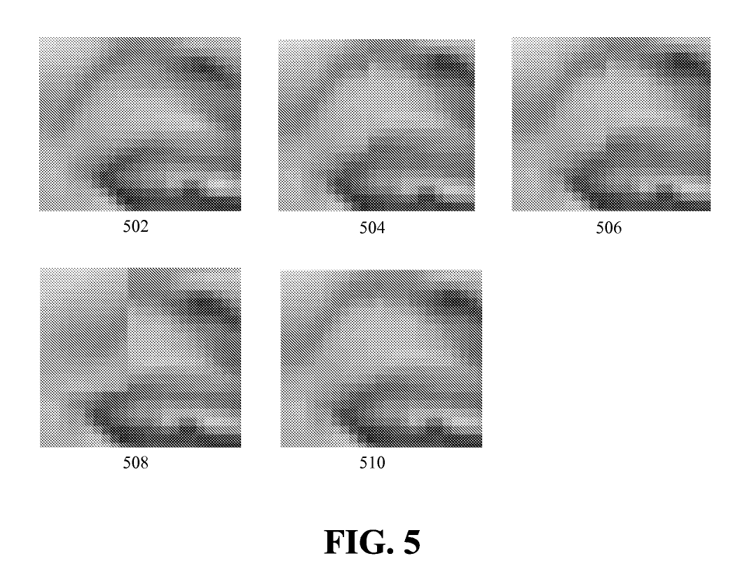

Referring briefly to FIG. 5, image quality data for an exemplary error concealment system in accordance with an aspect of the present invention is illustrated. Specifically, image 502 illustrates magnified detail of original frame 402, and images 504, 506, 508, and 510 respectively illustrate magnified detail of images 406, 408, 410, and 412. Similar to FIG. 4, it can be seen that image 510 corresponding to the concealed frame provided by the STBMA with weighting factor α=0.5 is smoother and has less artifacts compared to image 504 corresponding to the concealed frame provided by the traditional BMA.

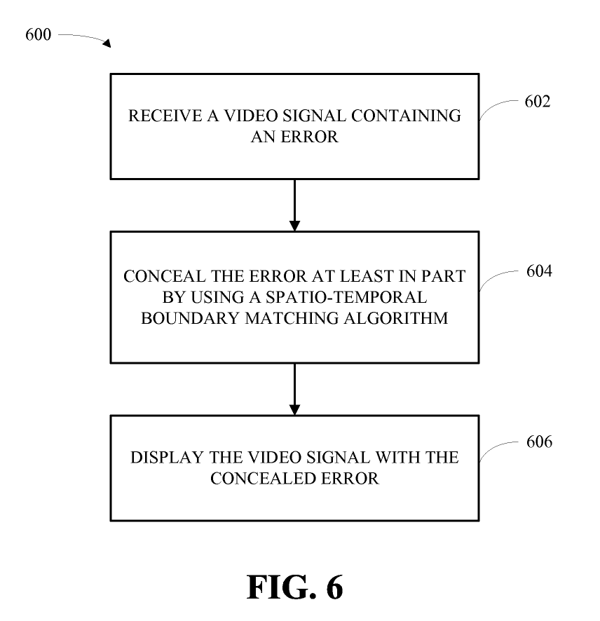

Turning now briefly to FIGS. 6-8, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

Furthermore, the invention may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers. . . ). Such components, inter alia, can automate certain mechanisms or processes performed thereby to make portions of the systems and methods more adaptive as well as efficient and intelligent.

Referring to FIG. 6, a method 600 of processing a video signal (e.g., video signal 12) in accordance with an aspect of the present invention is illustrated. The method 600 begins at 602, wherein a video signal containing an error is received (e.g., by receiving device 20). At 604, the error in the video signal is concealed (e.g., by error concealment component 22) at least in part by using a Spatio-Temporal Boundary Matching Algorithm. The method 600 then concludes at 606, wherein the video signal is displayed with the concealed error (e.g., by display component 24).

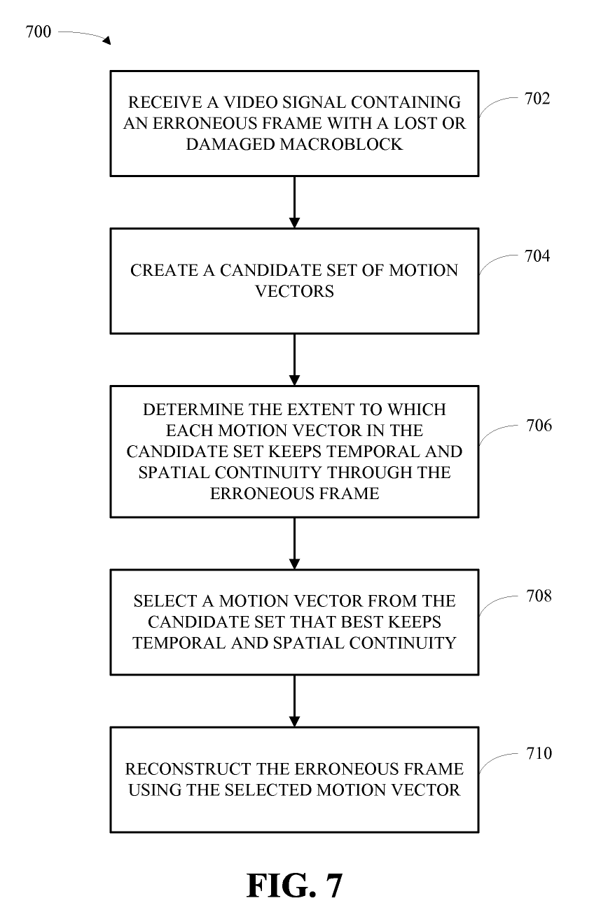

Turning to FIG. 7, a method 700 of concealing an error in a video signal in accordance with an aspect of the present invention is illustrated. The method 700 begins at 702 wherein a video signal containing an erroneous frame with a lost or damaged macroblock is received. Next, at 704, a candidate set of motion vectors is created. By way of a non-limiting example, the candidate set of motion vectors can include a zero motion vector, a collocated motion vector in a reference frame, and motion vectors corresponding to neighboring macroblocks. As another non-limiting example, the candidate set of motion vectors can include motion vectors corresponding to one or more macroblocks retrieved from a frame that precedes the erroneous frame and/or transformations on a given macroblock to account for motion through the erroneous frame. At 706, the extent to which each motion vector in the candidate set keeps temporal and spatial continuity through the erroneous frame is determined (e.g., by a temporal matching component 302 and a spatial matching component 304 and/or by using Equations ((2)-(8)). At 708, a motion vector is selected from the candidate set that best keeps spatial and temporal continuity through the erroneous frame as determined in 706. In one example, temporal continuity and spatial continuity can be assigned uneven weight in selecting a motion vector by adjusting a weighting factor (e.g., weighting factor α in Equation (2)). Finally, at 710, the erroneous frame is reconstructed (e.g., by reconstruction component 306) using the selected motion vector.

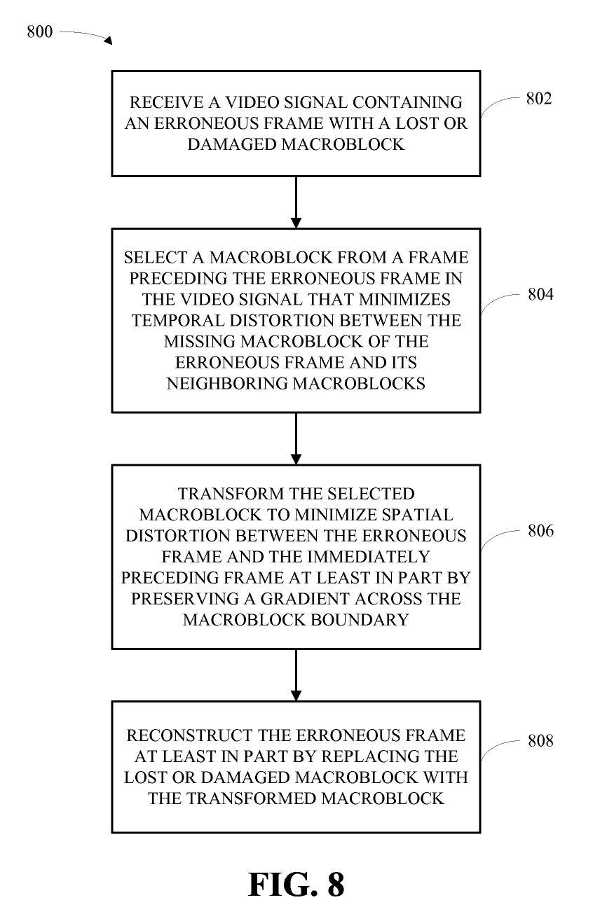

Referring now to FIG. 8, a method 800 of concealing an error in a video signal in accordance with an aspect of the present invention is illustrated. The method 800 begins at 802 wherein a video signal containing an erroneous frame with a lost or damaged macroblock is received. Next, at 804, a macroblock from a frame preceding the erroneous frame in the video signal is selected that minimizes temporal distortion between the missing macroblock of the erroneous frame and its neighboring macroblocks. At 806, the macroblock selected at 804 is transformed to minimize spatial distortion between the erroneous frame and the immediately preceding frame at least in part by preserving a gradient across the macroblock boundary. In a non-limiting example, the transformation in 806 can be performed iteratively until convergence is reached. In a further non-limiting example, the selection in 804 and the transformation in 806 can be assigned uneven priority by adjusting a weighting factor (e.g., weighting factor α). Finally, at 808, the erroneous frame is reconstructed at least in part by replacing the lost or damaged macroblock with the macroblock selected in 804 and/or transformed in 806.

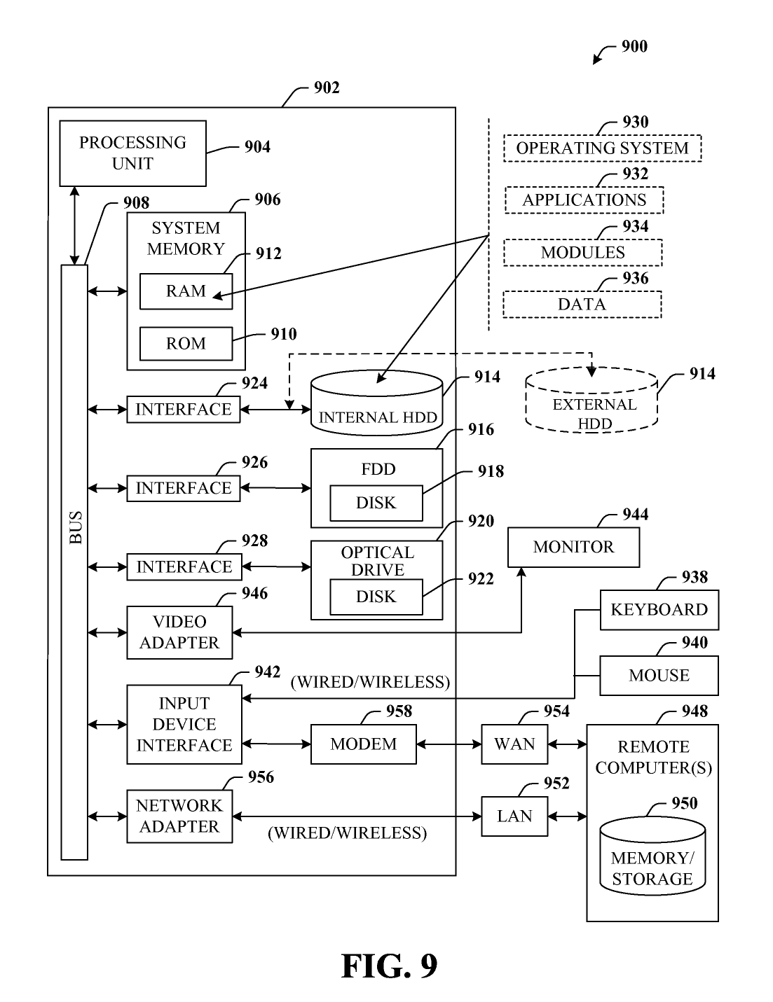

In order to provide additional context for various aspects of the subject invention, FIG. 9 and the following discussion are intended to provide a brief, general description of a suitable computing environment 900 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software. Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the example computing environment 900 includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA) that may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE-1394 interface technologies. Other external drive connection technologies are within contemplation of the subject invention.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, a serial port, an IEEE-1394 port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, telephone, etc. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band). Thus, networks using Wi-Fi wireless technology can provide real-world performance similar to a 10 BaseT wired Ethernet network.

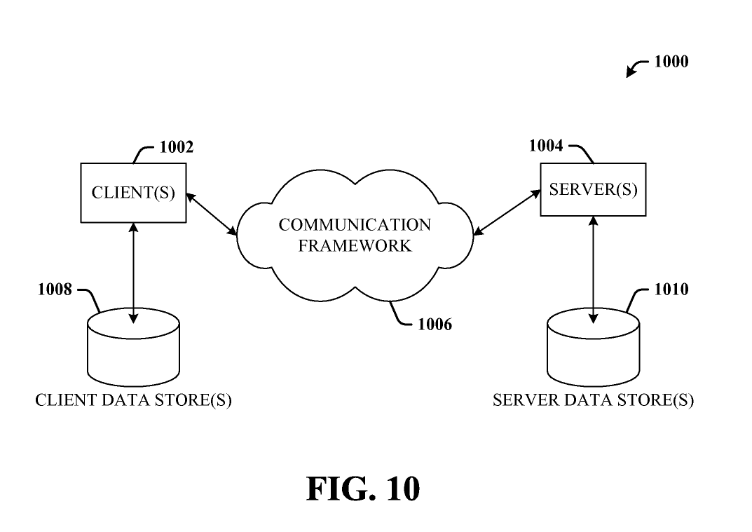

Referring now to FIG. 10, a block diagram of an example networked computing environment in which the present invention may function is illustrated. The system 1000 includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). One possible communication between a client 1002 and a server 1004 can be in the form of a data packet adapted to be transmitted between two or more computer processes. The data packet may include a video signal (e.g., video signal 12) and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002. Similarly, the server(s) 1004 are operatively connected to one or more server data store(s) 1010 that can be employed to store information local to the servers 1004.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A system for concealing a transmission error that causes an erroneous frame in a video signal, comprising:
a temporal matching component that determines extent to which one or more candidate blocks of correctly received data in the video signal keep temporal continuity through the erroneous frame of the video signal;
a spatial matching component that determines extent to which the one or more candidate blocks of correctly received data in the video signal keep spatial continuity through the erroneous frame of the video signal; and
a reconstruction component that selects a candidate block of correctly received data from the one or more candidate blocks of correctly received data based at least in part on the determinations of the temporal matching component and the spatial matching component and employs the selected candidate block to reconstruct the erroneous frame.

2. The system of claim 1, wherein the erroneous frame includes at least one missing or corrupted macroblock and the temporal matching component calculates an average sum of temporal distortion between an external boundary of each of the one or more candidate blocks of correctly received data and an external boundary of a plurality of macroblocks bordering the at least one missing or corrupted macroblock.

3. The system of claim 2, wherein the plurality of macroblocks bordering the at least one missing or corrupted macroblock includes only correctly received macroblocks.

4. The system of claim 2, wherein the plurality of macroblocks bordering the at least one missing or corrupted macroblock includes at least one macroblock that contains a concealed error.

5. The system of claim 1, wherein the erroneous frame includes at least one missing or corrupted macroblock and the spatial matching component calculates a difference between a gradient across an internal boundary of each of the one or more candidate blocks of correctly received data and a gradient across an internal boundary of a macroblock in a frame immediately preceding the erroneous frame having the same relative position as the missing or corrupted macroblock.

6. The system of claim 5, wherein the difference in gradients is calculated at least in part by calculating an average sum of absolute changes of a Laplacian estimator along a normal direction at the internal boundary of each of the one or more candidate blocks of correctly received data.

7. The system of claim 1, wherein the reconstruction component uses a weighting factor to determine relative weights to be given to the determinations of the temporal matching component and the spatial matching component in selecting a candidate block of correctly received data.

8. The system of claim 1, wherein the erroneous frame includes at least one missing or corrupted macroblock and the temporal matching component selects a macroblock from a frame preceding the erroneous frame in the video signal that exhibits a minimum amount of temporal distortion between an external boundary of the selected macroblock and an external boundary of a plurality of macroblocks that border the at least one missing or corrupted macroblock.

9. The system of claim 8, wherein the spatial matching component performs one or more transformations on the macroblock selected by the temporal matching component to minimize the difference between a gradient across the selected macroblock and a gradient across a macroblock in the immediately preceding frame having the same relative position as the missing or corrupted macroblock.

10. The system of claim 9, wherein the one or more transformations performed by the spatial matching component include adjusting an intensity of one or more pixels in the selected macroblock.

11. The system of claim 1, further comprising a display component that displays the video signal with the erroneous frame upon reconstruction of the erroneous frame by the reconstruction component

12. A method for concealing a transmission error in a video signal, comprising:
receiving a video signal having an erroneous frame;
creating a candidate set of motion vectors;
selecting a motion vector from the candidate set of motion vectors that best keeps temporal and spatial continuity through the erroneous frame; and
reconstructing the erroneous frame using the selected motion vector.

13. The method of claim 12, wherein the candidate set of motion vectors includes a zero motion vector, a collocated motion vector corresponding to a reference frame, and one or more motion vectors corresponding to blocks that border the lost or damaged macroblock

14. The method of claim 12, wherein the erroneous frame contains a missing macroblock and the selecting a motion vector includes:
selecting a macroblock from a frame preceding the erroneous frame in the video signal that exhibits a minimum amount of temporal distortion between the selected macroblock and a plurality of macroblocks that border the missing macroblock;
transforming the selected macroblock to minimize the difference in a gradient across the selected macroblock and a gradient across a macroblock in an immediately preceding frame having the same relative position as the missing or corrupted macroblock; and
selecting a motion vector from the candidate set of motion vectors that corresponds to the selected and transformed macroblock.

15. The method of claim 14, wherein the transforming includes adjusting an intensity of one or more pixels in the selected macroblock.

16. The method of claim 14, wherein the transforming is performed iteratively until a desired minimum gradient difference is reached.

17. The method of claim 12, wherein the selecting a motion vector includes selecting a motion vector from the candidate set of motion vectors based at least in part on a Spatio-Temporal Boundary Matching Algorithm.

18. A computer-readable medium having stored thereon instructions operable to perform the method of claim 12.

19. A system for concealing a transmission error in a video signal, comprising:
means for receiving a video signal containing an error;
means for determining a motion vector that optimally keeps temporal and spatial continuity through a frame in the video signal affected by the error; and
means for reconstructing the video signal using the determined motion vector.

20. The system of claim 19, wherein the means for determining a motion vector includes means for selecting a motion vector from a candidate set of motion vectors that minimizes spatial distortion through the frame in the video signal affected by the error at least in part by preserving a gradient through the frame.
